(19) United States
(12) Patent Application Publication
(10) Pub. No.: US 2018/0119979 A1
(43) Pub. Date: May 3, 2018

(54) CONNECTED LIGHT FIXTURE AND RELATED METHODS

(71) Applicant: DELTA T CORPORATION, Lexington, KY (US)

(72) Inventors: Alex Christopher REED, Lexington, KY (US); Marcus Landon BORDERS, Lexington, KY (US)

(21) Appl. No.: 15/568,128

(22) PCT Filed: Apr. 20, 2016
(86) PCT No.: PCT/US2016/028397

§ 371 Date: Oct. 20, 2017

Related U.S. Application Data
(60) Provisional application No. 62/150,061, filed on Apr. 20, 2015.

(51) Int. Cl. F24F 11/77; G05B 15/02

(52) U.S. Cl. CPC F24F 11/77; F24F 2110/10; G05B 2219/2614; G05B 15/02

(57) ABSTRACT

A system for controlling an environmental condition in a space includes one or more light fixtures, each including at least one sensor for sensing a condition of the space (such as temperature), a device for regulating the environmental condition of the space, and a controller for controlling the device based on the sensed condition. The device may comprise a fan, such as a ceiling fan or one forming part of a heating, ventilating, or air conditioning (HVAC) unit. Related systems and methods for controlling lighting are also disclosed.

This patent application claims the benefit of U.S. Provisional Patent Application Ser. No. 62/150,061, the disclosure of which is incorporated herein by reference. The disclosures of International Patent Application Ser. Nos. PCT/US15/27998 and PCT/US15/40392 are also incorporated herein by reference.

### TECHNICAL FIELD

This application relates generally to the regulation of environmental conditions and, more particularly, to a light fixture adapted to interconnect with other environmental regulation devices and provide information relevant to the control of such devices.

### BACKGROUND

Light fixtures are commonly used to provide light to occupied spaces, especially indoors. In the past, the ability of a light fixture (which may include one or more light bulbs) to work in connection with other environmental control devices, such as fans, HVAC units, thermostats, or the like, have largely been ignored. Hence, this disclosure proposes a light fixture adapted to interact with an environmental control system, such as for controlling an environmental condition, based on the output of associated sensors, which may be connected to the light fixture.

### SUMMARY

According to one aspect of the disclosure, a system for controlling a heating, ventilating, or air conditioning unit associated with the space is provided. The system includes a light fixture adapted for mounting to a wall or ceiling within the space, the light fixture including at least one sensor for sensing a condition in the space, and a controller adapted for controlling the heating, ventilating, or air conditioning unit based on the sensed condition. As can be appreciated, the heating, ventilating or air conditioning unit comprises a fan, and thus the sensor may comprise a temperature sensor and the controller may be adapted for regulating the speed of the fan based on the sensed temperature.

In one embodiment, the controller is a central controller for controlling a plurality of devices besides the light fixture, such as HVAC units or zone dampers. In such case, since the light fixture may provide the sensing function, the central controller does not include a temperature sensor. Thus, the system may operate without a conventional thermostat to control the HVAC unit(s). In this or another embodiment, a fan, such as a ceiling fan, is adapted for being controlled by the controller based on the sensed condition.

According to a further aspect of the disclosure, an environmental regulation system includes a light fixture adapted for mounting to a ceiling within a space. The light fixture includes at least one sensor for sensing a condition of the space, and a controller may be adapted for controlling a fan in the space based on the sensed condition. The fan may comprise a ceiling fan in the space, and the sensor may comprise a temperature sensor, such that temperature information provided may be used to regulate the operation of the fan.

In one embodiment, the light fixture is physically connected to the fan. In another embodiment, the fan is part of a heating, ventilating, or air conditioning unit, which may be adapted for being controlled by the controller based on the sensed condition. The controller may be a central controller for controlling a plurality of devices, such as HVAC units, and which central controller does not include a temperature sensor.

Still a further aspect of the disclosure pertains to a system for controlling an environmental condition in a space other than light. The system comprises a first light fixture adapted for mounting to a ceiling within the space, the light fixture including at least one sensor for sensing a condition of the space. A device is provided for regulating the environmental condition of the space. A controller is adapted for controlling the device based on the condition sensed by the at least one sensor.

In any disclosed embodiment, unless otherwise specified, the at least one sensor may be selected from the group consisting of a temperature sensor, a humidity sensor, an occupancy sensor, a motion sensor, a light level sensor, and any combination thereof. For example, the at least one sensor may comprise a passive infrared sensor for sensing temperature or occupancy. The system may further include a camera connected to the light fixture, and the at least one sensor may comprise an occupancy or motion detector for activating the camera. In this regard, a security system may be in communication with the controller.

The light fixture may comprise a recessed light fixture or a surface mounted light fixture. The at least one sensor may comprise a modular sensor pack and the light fixture may include a connector adapted for connecting to the modular sensor pack. The light fixture may include a router for connecting to a communication network, and may also include the controller. Alternatively, the controller may be a mobile device or a wall-mountable device. A wearable device may be adapted for either being sensed by the sensor or communicating with the controller to control the device, and the light fixture may activate by way of a voice command, a gesture, a remote control, a sensor associated with an object, or a wearable device.

In a further aspect of the disclosure, a system for controlling lighting in a space is provided. The system comprises a first light fixture for lighting the space, a first sensor for sensing an amount of ambient light, a second light fixture for lighting the space, and a controller for regulating the first and second light fixtures differently based on the amount of ambient light sensed by the first sensor. The controller may be adapted for regulating the first light fixture based on a proximity to a source of natural light, and/or may be adapted for regulating a fan or a heating, ventilating, or air conditioning unit based on the amount of ambient light.

Yet another aspect of the disclosure pertains to a system for controlling lighting in a space. The system comprises a first light fixture for providing light to the space, and a controller for regulating the first light fixture based on proximity to a source of natural light. The controller may be adapted for regulating the fan or HVAC unit based on the amount of ambient light. A second light fixture may be regulated by the controller to provide a light output corresponding to the first light fixture.

According to still a further aspect of this disclosure, a system for regulating an environment in a space is provided. The system includes a light fixture with a sensor for sensing a condition of the space. A thermostat associated with the space is adapted for controlling the environment based on the sensed condition. The thermostat may thus rely on the condition as sensed by the lighting fixture for operating a device, such as an HVAC unit, as an alternative to or in addition to its own sensing capabilities.

This disclosure also pertains to methods for regulating an environment in a space. For instance, one method disclosed comprises sensing an environmental condition in the space using a light fixture including at least one sensor, and controlling air temperature or circulation in the space based on the sensed environmental condition. The controlling step may comprise regulating a fan located in the space, or regulating a heating, ventilating, or air conditioning unit. The sensing step may comprise sensing whether the space is occupied using an occupancy sensor associated with the light fixture, sensing a temperature within the space using a temperature sensor, and/or sensing a light level within the space using a light sensor. The method may further include the step of controlling a light level of the light fixture based on the sensed environmental condition.

A further part of the disclosure relates to a method of regulating a controller for controlling an environmental condition based on a first temperature near the controller. The method includes sensing a second temperature at a location remote from the controller using a sensor connected to a light fixture. If the temperature at the remote location does not correspond to the first temperature, the controller controls or regulates the environmental condition.

In one embodiment, the method further includes the step of sensing an amount of light in the space using the sensor, and causing the controller to regulate the environmental condition based on the sensed amount of light. The method may also include the step of providing a user input for inputting information regarding the presence of sources of natural light. This inputted information may be used to regulate the environmental condition based on the presence of natural light sources.

Still further, this disclosure relates to a method of regulating light conditions in a space influenced by a source of natural light. The method comprises providing first and second light fixtures for lighting the space, the first light fixture being closer to the source of natural light than the second light fixture, and regulating the first light fixture based on a detected amount of natural light. The regulating step may comprise regulating the first light fixture without regulating the second light fixture, or regulating the first and second light sources together.

Yet another aspect of this disclosure relates to a method for regulating an environment in a space. The method comprises sensing an amount of ambient light in the space at two different times using a light sensor associated with a light fixture, and then controlling a thermostat associated with the space based on the difference in the amount of ambient light. The controlling step may comprise preventing the thermostat from activating an associated HVAC unit when a temperature sensed by the thermostat is within a pre-determined amount relative to a set temperature despite the difference in ambient light.

### BRIEF DESCRIPTION OF THE DRAWING FIGURES

The accompanying drawing figures incorporated herein and forming a part of the specification illustrate several aspects of the systems and methods of the disclosure, and together with the description serve to explain certain principles thereof.

FIG. 1 illustrates schematically one possible embodiment of the system according to the present disclosure; and

FIG. 2 illustrates schematically another possible embodiment of the system according to the present disclosure.

Reference will now be made in detail to the present preferred embodiments of the systems and methods, examples of which are illustrated in the accompanying drawing figures.

### DETAILED DESCRIPTION

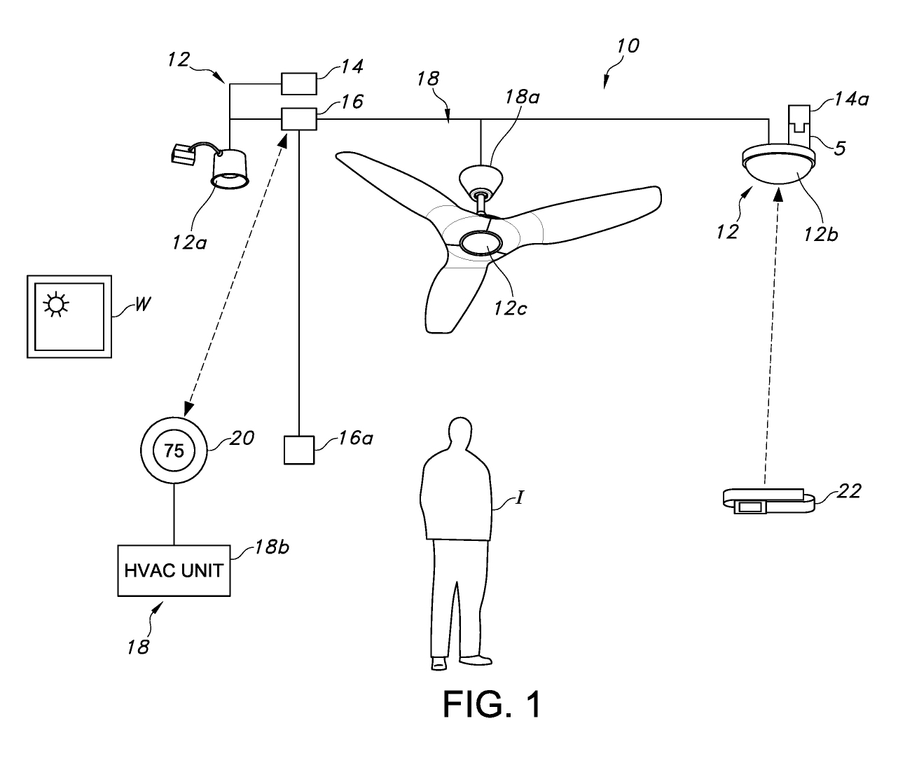

Reference is now made to FIG. 1, which schematically illustrates one possible embodiment of a system or system 10 including one or more light fixtures 12 (each of which may include one or more light sources or emitting elements, such as LEDs). FIG. 1 illustrates two different versions of light fixtures 12, one of which is commonly referred to as a recessed or “can” light 12a, and the other of which is a surface mounted “dome” light 12b (which could also be adapted for use in connection with a canned or recessed fixture). In this particular embodiment, the light fixture 12 is thus generally round or circular in cross-section, and is adapted for mounting to a ceiling within the space. Despite the illustration of one possible arrangement, the technologies described herein may be applied to light fixtures in other forms, including hanging/pendant light fixtures (e.g., High Bay LED luminaires), wallpacks, or standalone light fixtures (which are sometimes called pedestal lights). The same is true regarding the manner of illumination created by the light fixture 12 which can be of any desired type (e.g., incandescent, fluorescent, LED, etc.).

The light fixture(s) 12 may be provided with one or more sensors for sensing a condition of the living or working space associated with the light produced, and operable regardless of the on/off state of the light fixture. By way of example, and not limitation, the sensor 14 or sensors may be selected from one or more of each of a temperature sensor, a humidity sensor, an occupancy sensor (such as for detecting the presence or absence of an individual I), a light sensor (as discussed in more detail below), a motion detector, or any combination thereof. The temperature and occupancy/motion sensors, if present, may be of the non-contact type using invisible (infrared) energy, to detect temperature or occupancy/motion at a location remote from the sensor itself (i.e., anywhere outside of the light fixture 12 in the corresponding living or working space where the lighting condition is regulated by the illumination provided by the lighting fixture or an associated one), but the temperature sensor could also be a more conventional type of sensor, such as a thermocouple.

Any sensed condition may be used by a controller 16 associated with the fixture 12 to control it, such as by activating it, deactivating it, or otherwise regulating its operation. The controller 16 is shown as being connected directly to the fixture 12, but may comprise a wall mounted control or a portable control, such as a mobile device or computer (e.g., a smart phone, laptop, wireless (IR) remote, etc.) or the like.

In any case, the controller 16 may receive information from the sensor(s) 14 and use it to control the environmental conditions in the space in other ways. For example, using the information from the sensor(s) 14, the controller 16 via the connection with the light fixture 12 (and, more specifically, the associated sensor(s)) may be adapted to control one or more devices 18 for regulating an environmental condition, such as those for regulating the sensed or actual temperature in the space, or for regulating the amount of natural light or air (such as through the control of window treatments, dampers, etc.). As shown, the device 18 may include a fan associated with the space and for providing a measure of air movement or circulation, such as an overhead or ceiling fan 18a (which may also include a physically connected lighting fixture 12c, which may be controlled by the controller 16 as well). The device 18 may additionally or alternatively be a device for conditioning air for the space, such as a heating, ventilating, and/or air conditioning (HVAC) unit 18b (which need not perform all of these functions). The transmission of information may be done via wired or wireless communication with the other device(s), which for avoidance of doubt may include other lighting fixtures (unless otherwise indicated herein).

Thus, by way of example, the sensor 14 associated with the light fixture 12 may detect a temperature of the space and deliver a corresponding signal to turn on the fan 18a and/or deliver conditioned air to the space via the HVAC unit 18b, such as when the temperature sensed exceeds a pre-determined value. The controller 16 may communicate with a thermostat 20 associated with the space, which may be adapted for controlling the operation of the device(s) 18 via a user input regarding a desired environmental condition, such as for example temperature (or alternatively, the sensor 14 may communicate information to a controller associated with the thermostat, such as forming part of it). In any case, if the sensed temperature from sensor 14 exceeds the set temperature of the thermostat 20 in a cooling mode, the controller 16 may cause the device 18 (or thermostat itself) to operate in an effort to regulate the temperature accordingly.

Likewise, if the sensed temperature is below the set temperature in a heating mode, then the adjustment can be made to increase the temperature by regulating the HVAC unit 18b via thermostat, or regulating the fan 18a (such as by changing its speed or direction), or both. However, the system 10 may also operate without the need for a conventional thermostat 20, such that the controller 16 controls the HVAC unit 18b (and also possibly fan 18a) directly based on the sensed condition and a pre-determined condition (such as a user inputted limit corresponding to the condition being sensed, which may be provided by a user interface 16a associated with or remote from the controller, or may be provided by other networked devices).

The sensed condition(s) determined by the light fixture sensor 14 may also be used to compare with other sensed conditions, either by other sensors associated with light fixture(s) or different sensors entirely. For example, a temperature sensed by a sensor 14 associated with a light fixture 12 may be compared to a temperature sensed at a location associated with the thermostat 20. If the comparison suggests that destratification of the air may be beneficial to resolve the situation, the controller 16 may regulate the operation of the fan 18b accordingly. Subsequent sensing may then determine that the situation has resolved and, if not, may cause the HVAC unit 18a to activate, despite the fact that the setpoint temperature thereof may not be exceeded. The system 10 may also or alternatively be adapted to balance the temperature across more than one room by using another device 18, such as a controlled diffuser, vent, window, window treatment, or like device for regulating an environmental condition.

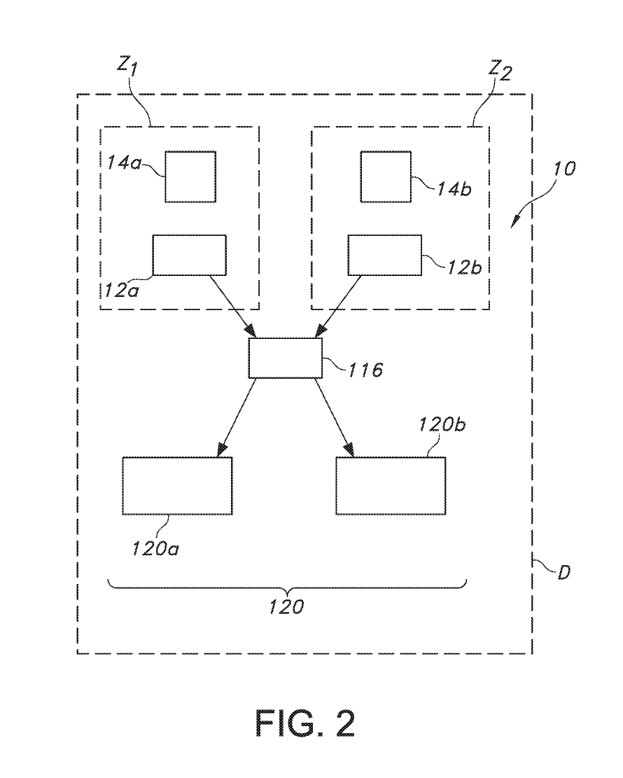

In the case of multiple lighting fixtures 12a, 12b (which are shown as being different types of purposes of illustration only, and may be the same), the conditions sensed by the associated sensor(s) 14 may be compared to make an assessment of the overall condition of the space (or multiple spaces, if applicable, which may be considered different zones, as indicated in FIG. 2). Regulation of the device 18 (such as HVAC unit 18b) may then be made accordingly, including possibly based on an average or mean value of the sensed conditions, or by regulating the flow of conditioned air to a particular space (such as by using controlled dampers or registers, for instance). The detection of occupancy may not only be used to regulate the light fixture 12 (such as by turning it off after a period of non-occupancy), but may also be used to regulate the device(s) 18 (such as by causing the fan 18a to turn on or off, or regulating the HVAC unit 18b based on whether an associated space is occupied or not).

In addition or instead of those mentioned above, the sensor 14 associated with any light fixture 12 may comprise a sensor for sensing an ambient light level (which may be considered as a light level including light produced by the light fixture 12 and background light, such as that coming from other sources, and including any natural light). Based on the sensed ambient light level, the controller 16 may then adjust the output of any or all of the light fixtures 12 accordingly. The maximum and minimum intensity may also be adjusted by the user providing input to the controller 16, such as via any communication device (e.g., a remote control, which as may be a mobile device or a fixed (e.g., wall mounted) device, as described in International Application Ser. No. PCT/US15/40392).

To reduce the influence of the associated light source, it may be possible for the light fixture 12 itself to reduce its own state continually until the overall ambient light amount is reduced, thus indicating the point at which the associated light source is supplementing any alternative artificial or natural light source. It may also be possible for any light fixture(s) 12 associated with the space to momentarily halt the production of artificial light in order to allow a light sensor (which may be sensor 14) to gain an indication of the amount of ambient light created without the contribution of the associated light source. The light sensor may be remote from the light fixture 12, such as on a wall-mounted control or perhaps even near a source of natural light (e.g., a window or skylight), and communicate with the controller 16 to control the light fixture(s). The fixture(s) 12 could also include plural light sensors, such as for example one for sensing external light beneath the fixture and one for sensing internal light produced by the light source.

In addition to controlling the amount of light output, the controller 16 may also control the light fixture(s) 12 to regulate the color of the light produced (e.g., the color temperature). This may be done to match the existing color temperature of multiple lighting fixtures within a space, to promote a better sleeping environment, to simulate the sunrise or sunset (including based on information regarding the known time of sunrise or sunset at a particular geographic location, which may be determined using a GPS system or like device also capable of communicating over a network associated with controller 16, or by a user interface for entering information such as zip code or physical address), or as a matter of personal preference. For instance, if a user using a user interface sets the color of one fixture, such as 12a, this information may be communicated to other fixtures, such as fixture 12b, on the same network, so as to avoid the need for the user to individually control each fixture (if this is a desired setting; of course, it may also be possible for the user to individually control the color temperature of the fixtures individually to achieve a desired effect).

The controller 16 may also be adapted for recording user inputs and predicting a desired operation. This may include a particular light temperature or intensity at given times of the day or under given conditions, the light status (on/off), the duration of the particular condition, or any combination thereof. As but one example, the light fixture 12 may operate in a “night light” mode during the hours in which a person may be sleeping (which may be indicated to the controller 16 by the person, or may be automated based on a given time of day). The night light operation may alternatively or additionally be conditioned based on the detection of motion about a room that is not consistent with common sleeping motions (such as by using thermal imaging to detect turning from one side to the other), or based on another device, such as a wearable or a furniture item (e.g., a sensor in a bed or bed accessory). Likewise, the light fixture 12 may produce the light periodically in accordance with a period of detected non-occupancy as a measure of security.

Other devices 18 may also be in communication with the controller 16 of the lighting fixture 12. For example, a security system or like device may provide inputs to the controller 16 for controlling the operation of lights (such as to turn them on in an alert situation, and possibly to generate a sound through an associated audio device or speaker, which may be connected to the light fixture 12). Likewise, the light fixture(s) 12 via sensor(s) 14 may inform the security system of conditions such as occupancy or temperature in order to provide an indication of possibly unexpected conditions. The fixture 12 may also include a camera, which may be activated by a user or automatically, such as by the detection of movement or occupancy by a sensor (such as sensor 14 associated with the light fixture, or a different sensor).

Any or all of the light fixtures 12 may also serve as a network gateway, or “border router.” This enables the light fixture 12 to deliver data over a network, such as the Internet, and also receive data therefrom (as well as to transmit or receive information to or from other devices 18 on the same network). This mode of communication may thus be used to regulate the operation of not only the associated light fixture(s) (e.g., such as by turning the light on or off remotely), but also any device 18 in communication therewith. For instance, in the above example, the light fixture 12 via controller 16 may retrieve information on sunset or sunrise times and gradually increase the amount of light generated by an associated light fixture, or possibly open or close window treatments (e.g., blinds, shades, or the like) to admit or decrease the amount of light. The particular control may be pre-determined or communicated to the controller 16 by the user.

The light fixture 12 including the sensor 14 may be activated in a variety of ways. As one example, the sensor 14 may comprise an occupancy sensor for detecting the presence of a person (such as individual I) in the corresponding space. This information may be used to activate any associated lighting fixture, including a different one in a different location (in the same room or otherwise) from the fixture that detected the occupancy. The associated controller 16 may then be used to regulate the operation of the light fixture 12 and/or other device(s) 18 based on the sensed presence.

Alternatively, activation of the light fixture 12 may be done audibly, by gesture, by a remote control (mobile or wall mounted), by a sensor associated with another object (including possibly an item of furniture, such as a bed, couch, or accessory therefor), by a wearable device (e.g., wrist device 22 in FIG. 1, which may wirelessly communicate with the light fixture, illustrated as surface mounted light fixture 12b but it could be any form as noted), as a result of a network communication. Such a communication may be, for example, a direction received over a network (e.g., the Internet) based on communication with other connected devices, or based on environmental conditions, such as the weather (including an emergency alert, such as a tornado or storm warning), sunset/sunrise, etc., a time-based event (e.g., a pre-programmed schedule), a scene-based event (e.g., laying down for bed, turning on a television, etc.), or sensed activity in the space (as contrasted with just occupancy). The activation may be done in a particular way to provide an indication to the occupant of a certain event, such as by modulating light intensity or color in the event of an emergency or other need for alert.

In one possible implementation, the sensor 14 may take the form of a modular sensor pack 14a associated with the light fixture 12 (as indicated on the right hand side of FIG. 1). This may be accomplished by providing a suitable connector or socket S in the lighting fixture 12, as indicated. In this manner, the sensing capabilities of each lighting fixture 12 may be adapted to the particular situation. The socket S or other connector may also be adapted to connect with a communications module for communicating information to or from the light fixture, including audio, video, or the like.

With continued reference to FIG. 1, an arrangement is also depicted where first and second light fixtures 12a, 12b are present in a single space in which conditions are controlled by system 10, as may be common but certainly is not a requirement. As noted above, an associated controller 16, which may be a wall controller, may be used to control the light output from the light fixtures 12a, 12b independently in order to maximize efficiency or achieve a desired light level balance. For instance, if the space associated with the light fixtures 12a, 12b is a room with a window W for admitting natural light, the light fixture 12a closest to the window may have an associated sensor 14a for sensing the natural light (which may be done as noted above by either momentarily suspending the production of artificial light). The controller 16 may then regulate the light fixture 12a closest to the window W, such as by lowering the light output, without adjusting another networked light fixture present, such as fixture 12b, in order to reduce energy usage given the amount of natural light present in the same space that receives the light output from fixture 12a, yet without sacrificing the overall level of light present. Likewise, the controller 16 may dim or brighten some or all fixtures 12a, 12b associated with the space equally to compensate for a sensed amount of natural light, which may be done to balance the amount of natural light and artificial light present in the space.

As noted above, the controller 16 may be associated with a user interface 16a for allowing a user to input certain information relating to the space to be illuminated by light fixture(s) 12a or 12(b). For example, the user may provide information on sources of natural light, such as windows (in ceilings or walls, and including structures such as light pipes). Based on this information, then the controller 16 may regulate aspects of the system 10 accordingly. Thus, as but one example, if a space is indicated as having no windows, then a sensed increase in light by any light sensor 14 would be understood to be less likely to come from natural light than some other source of light (such as another light fixture). In such case, associated fan(s), HVAC unit(s), or other environmental control devices may be regulated accordingly to account for the conditions present.

If a space is indicated as having one or more windows W, then a significant or sudden increase in the detected amount of ambient light may indicate that natural light is entering through the window(s). If an associated thermostat 20 is also registering an increase in temperature, despite a smaller (or no) change in temperature being sensed by a temperature sensor 14, which again may be associated with a light fixture 12, then the response of any device, such as fan 18a or HVAC unit 18b, may be regulated accordingly (such as by dampening the response provided because the rise in temperature may be presumed to be a result of natural light entering window W and impacting the thermostat 20, rather than an increase in the overall temperature of the space). Predicted or reported weather conditions may also be used with similar effect (i.e., if a sunny day is predicted, which may be determined by obtaining information over a communications network associated any device on the network) and the space is associated with a window W, then an increase in natural light may be presumed to be from natural light, in which case the thermostat 20 may be regulated accordingly.

Reference is now made to FIG. 2, which illustrates a further embodiment according to aspects of this disclosure. In this embodiment, no conventional, wall-mounted thermostat (such as element 20 in FIG. 1) associates with the space in which the system 10 operates. Rather, information from sensor(s) integrated with the light fixture(s) 12a, 12b may be delivered directly to a central controller 116 for controlling one or more HVAC units 120 associated with the space, which may be a single dwelling D (such as a house or building). Specifically, sensor data from a sensor 14a (light, temperature, occupancy, or any other condition relevant to controlling environmental conditions) associated with a first zone Z1 governed by a first HVAC unit 120a may be provided to central controller 116 (which need not include any temperature sensing capabilities), and data from sensor 14b (which may be the same or different as first sensor 14a) may be similarly used for controlling a first HVAC unit 120b for a second zone. Of course, the arrangement is not limited to two HVAC units or a single central controller 116, but in any case, it avoids the need for separate thermostats and light fixtures for regulating environmental conditions. Zone dampers may also be provided for control by central controller 116 to allow for the provision of or transfer of air to or from different zones.

Having shown and described various embodiments, further adaptations of the systems and methods described herein may be accomplished by appropriate modifications by one of ordinary skill in the art without departing from the scope of the disclosure. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the disclosure should be considered in terms of claims that may be presented, and is understood not to be limited to the details of structure and operation shown and described in the specification and drawings.

1. A system for controlling a heating, ventilating, or air conditioning unit associated with the space, comprising:
a light fixture adapted for mounting to a ceiling within the space, the light fixture including at least one sensor for sensing a condition in the space; and
a controller adapted for controlling the heating, ventilating, or air conditioning unit based on the sensed condition.

2. The system of claim 1, wherein the heating, ventilating or air conditioning unit comprises a fan, the sensor comprises a temperature sensor, and the controller is adapted for regulating the speed of the fan based on the sensed temperature.

3. The system of claim 1, wherein the controller is a central controller for controlling a plurality of devices besides the light fixture, such as HVAC units or zone dampers.

4. The system of claim 3, wherein the central controller does not include a temperature sensor.

5. The system of claim 1, further including a fan adapted for being controlled by the controller based on the sensed condition.

6. The system of claim 5, wherein the fan comprises a ceiling fan.

7. A system for regulating an environment in a space, comprising:
a light fixture adapted for mounting to a ceiling in the space, the light fixture including at least one sensor for sensing a condition in the space;
a heating, ventilating, or air conditioning unit for regulating the environmental condition of the space; and
a controller adapted for controlling the heating, ventilating, or air conditioning unit based on the sensed condition.

8. The system of claim 7, wherein the heating, ventilating or air conditioning unit comprises a fan, and the sensor comprises a temperature sensor for regulating the speed of the fan.

9. The system of claim 7, wherein the controller is a central controller for controlling a plurality of devices, such as HVAC units or zone dampers.

10. The system of claim 9, wherein the central controller does not include a temperature sensor.

11. The system of claim 7, further including a fan adapted for being controlled by the controller based on the sensed condition.

12. A system for regulating an environment in a space, comprising:
a light fixture adapted for mounting to a ceiling within the space, the light fixture including at least one sensor for sensing a condition of the space;
a fan for regulating the environmental condition of the space; and
a controller adapted for controlling the fan based on the sensed condition.

13. The system of claim 12, wherein the fan comprises a ceiling fan in the space, and the sensor comprises a temperature sensor.

14. The system of claim 12, wherein the light fixture is physically connected to the fan.

15. The system of claim 12, wherein the fan is part of a heating, ventilating, or air conditioning unit.

16. The system of claim 12, further including a heating, ventilating or air conditioning unit adapted for being controlled by the controller based on the sensed condition.

17. The system of claim 12, wherein the controller is a central controller for controlling a plurality of devices, such as HVAC units or zone dampers.

18. The system of claim 17, wherein the central controller does not include a temperature sensor.

19.-54. (canceled)
